(19) United States
(12) Patent Application Publication
(10) Pub. No.: US 2026/0034448 A1
(43) Pub. Date: Feb. 5, 2026

(54) ENVIRONMENT AUDIO PROCESSING METHOD AND APPARATUS, ELECTRONIC DEVICE, STORAGE MEDIUM, AND PROGRAM PRODUCT

(71) Applicant: Tencent Technology (Shenzhen) Company Limited, Shenzhen (CN)

(72) Inventors: Xiaoxing ZHOU, Shenzhen (CN); Weilin ZHANG, Shenzhen (CN); Guojun HONG, Shenzhen (CN)

(21) Appl. No.: 19/354,699

(22) Filed: Oct. 9, 2025

Related U.S. Application Data
(63) Continuation of application No. PCT/CN2024/104864, filed on Jul. 11, 2024.

(30) Foreign Application Priority Data
Sep. 22, 2023 (CN) 202311245987.9

(51) Int. Cl. A63F 13/54; A63F 13/52

(52) U.S. Cl. CPC A63F 13/54; A63F 13/52

(57) ABSTRACT

A method for processing an environment audio in a virtual scene is performed by an electronic device. The method includes: displaying a user interface, the user interface including a virtual scene and the virtual scene including at least one environment object; determining at least one environment type corresponding to the virtual scene based on an attribute of the at least one environment object; determining, based on the at least one environment type, at least one environment sound effect layer included in the virtual scene; generating a sound effect configuration file for each environment sound effect layer, and obtaining environment data of the at least one environment object; and rendering and playing an environment audio based on the sound effect configuration file and the environment data.

### CROSS-REFERENCE TO RELATED APPLICATIONS

This application is a continuation application of PCT Patent Application No. PCT/CN2024/104864, entitled “ENVIRONMENT AUDIO PROCESSING METHOD AND APPARATUS, ELECTRONIC DEVICE, STORAGE MEDIUM, AND PROGRAM PRODUCT” filed on Jul. 11, 2024, which claims priority to Chinese Patent Application No. 202311245987.9, entitled “METHOD AND APPARATUS FOR RENDERING AND PLAYING ENVIRONMENT AUDIO, ELECTRONIC DEVICE, AND STORAGE MEDIUM” filed with the China National Intellectual Property Administration on Sep. 22, 2023, all of which are incorporated by reference in their entirety.

### FIELD OF THE TECHNOLOGY

This application relates to the field of audio technologies, and in particular, to an environment audio processing method and apparatus, an electronic device, a storage medium, and a program product.

### BACKGROUND OF THE DISCLOSURE

With the development of information technologies, audio technologies are increasingly applicable in various fields. Particularly, environment audio may be widely applied to various fields such as a game field, a virtual reality (VR) field, and movie and television production.

Using the game field as an example, a game player may control a virtual object to perform a game operation. After the virtual object enters a scene, to enhance listening experience of the game player and cause the game player to feel immersive, corresponding sound may be played based on an environment object displayed in the scene. However, one virtual scene may include many environment objects, and environment sounds corresponding to the environment objects are complicated and inharmonious, resulting in poor auditory experience.

Therefore, to further improve the auditory experience, how to render and play an environment audio has become a key issue.

### SUMMARY

Embodiments of this application are intended to provide an environment audio processing method and apparatus, an electronic device, a storage medium, and a program product. To achieve the foregoing objective, the embodiments of this application provide the following technical solutions.

According to an aspect, an embodiment of this application provides a method for processing an environment audio in a virtual scene, the method including:
displaying a user interface, the user interface including a virtual scene and the virtual scene including at least one environment object;
determining at least one environment type corresponding to the virtual scene based on an attribute of the at least one environment object;
determining, based on the at least one environment type, at least one environment sound effect layer included in the virtual scene;
generating a sound effect configuration file for each environment sound effect layer, and obtaining environment data of the at least one environment object; and
rendering and playing an environment audio based on the sound effect configuration file and the environment data.

According to another aspect, an embodiment of this application further provides an electronic device, the electronic device including a memory and a processor, the memory having a computer program stored therein, and the computer program, when executed by the processor, causing the electronic device to implement the foregoing environment audio processing method.

According to another aspect, an embodiment of this application further provides a non-transitory computer-readable storage medium, the storage medium having a computer program stored therein, the computer program, when executed by a processor of an electronic device, causing the electronic device to implement the foregoing environment audio processing method.

### BRIEF DESCRIPTION OF THE DRAWINGS

To describe technical solutions in embodiments of this application more clearly, the accompanying drawings required for describing the embodiments of this application are briefly described below.

FIG. 1A is a schematic diagram of an implementation environment according to an embodiment of this application.

FIG. 1B is a schematic diagram of an environment sound system product according to an embodiment of this application.

FIG. 2 is a schematic diagram of operations for design of an environment audio according to an embodiment of this application.

FIG. 3 is a schematic flowchart of an environment audio processing method according to an embodiment of this application.

FIG. 4 is a schematic diagram of audio layering of an environment type according to an embodiment of this application.

FIG. 5 is a schematic diagram of generating a sound effect configuration file for an environment sound effect layer according to an embodiment of this application.

FIG. 6 is a schematic diagram of classification of an environment sound effect layer according to an embodiment of this application.

FIG. 7 is a schematic diagram of sound effect design contents of different sound effect types according to an embodiment of this application.

FIG. 8 is a schematic structural diagram of an audio configuration file according to an embodiment of this application.

FIG. 9 is a schematic diagram of a distribution type of an environment object according to an embodiment of this application.

FIG. 10 is a schematic diagram of environment data processing according to an embodiment of this application.

FIG. 11 is a schematic diagram of data expansion according to an embodiment of this application.

FIG. 12 is a schematic diagram of rendering and playing an audio based on environment data according to an embodiment of this application.

FIG. 13 is a schematic diagram of an environment audio rendering system according to an embodiment of this application.

FIG. 14 is a schematic structural diagram of an environment audio processing apparatus according to an embodiment of this application.

FIG. 15 is a schematic structural diagram of an electronic device according to an embodiment of this application.

### DESCRIPTION OF EMBODIMENTS

Embodiments of this application are described below with reference to the accompanying drawings of this application. The following implementations described with reference to the accompanying drawings are exemplary descriptions for explaining technical solutions of the embodiments of this application, and do not limit the technical solutions of the embodiments of this application.

A person skilled in the art may understand that, unless specifically stated, singular forms “a”, “an”, “the”, and “said” used herein may also include plural forms. Terms “include” and “comprise” used in the embodiments of this application mean that respective features may be implemented as presented features, information, data, steps, operations, elements, and/or components, but do not exclude implementation as other features, information, data, steps, operations, elements, components, and/or a combination thereof, and the like supported by the technical field. When an element is referred to as being “connected” or “coupled” to another element, the element may be directly connected or coupled to another element, or may mean that a connection relationship is established between the element and another element by using an intermediate element. In addition, the “connection” or “coupling” used herein may include wireless connection or wireless coupling. A term “and/or” used herein indicates at least one of items limited by the term. For example, “A and/or B” may be implemented as “A”, “B”, or “A and B”. When a plurality of (two or more) items are described, if a relationship among the plurality of items is not clearly limited, the plurality of items may refer to one, more, or all of the plurality of items. For example, the description of “a parameter A includes A1, A2, and A3” may be implemented as that the parameter A includes A1, or A2, or A3, or may be implemented as that the parameter A includes at least two of the three parameters A1, A2, and A3.

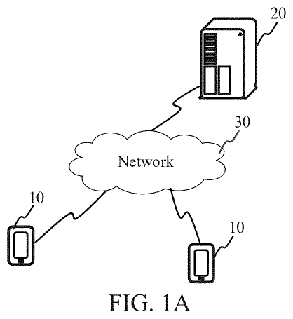

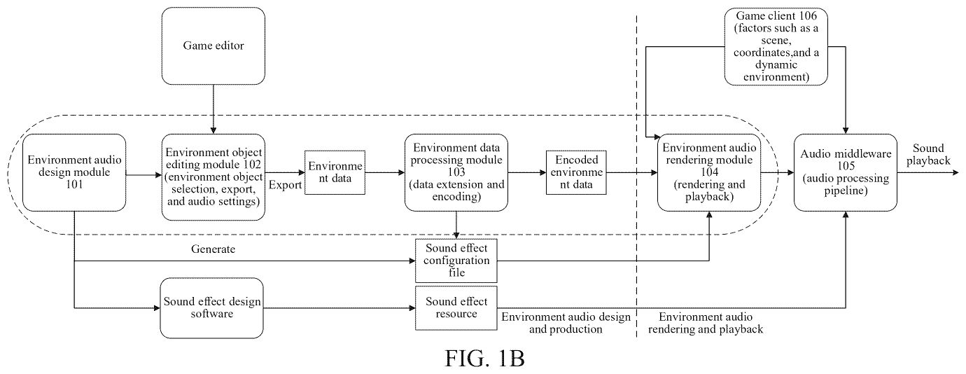

FIG. 1A is a schematic diagram of an implementation environment according to an embodiment of this application. The implementation environment may include a terminal device 10 and a server 20.

The terminal device 10 may be a portable electronic device such as a mobile phone, a tablet computer, a game console, an e-book reader, a multimedia playback device, and a wearable device. A client of a game application may be installed in the terminal device 10.

The server 20 is configured to provide a background service for the client of the application (for example, a game application) in the terminal device 10. For example, the server 20 may be a background server of the foregoing application (for example, the game application). The server 20 may be one server, or may be a server cluster including a plurality of servers, or a cloud computing service center.

The terminal device 10 may communicate with the server 20 through a network 30. The network 30 may be a wired network, or may be a wireless network.

In the related art, two environment audio rendering and playback methods are involved, which are specifically described as follows.

A first manner is an object-based binding manner. All environment audio playback is bound to an environment object instance in a virtual scene.

A second manner is an area-based playback manner. An area range is defined in a scene to determine to trigger specific environment audio.

In the first object-based binding manner, implementation is simple, and a correspondence between each environment audio and the environment object may be intuitively seen. However, for a large scene, a quantity of environment objects becomes very large, and each environment object is individually bound to a playback mode of the environment audio, which causes a large quantity of environment audios to be simultaneously played, thereby resulting in severe interference. Moreover, due to frequent changes of the environment objects in the scene, a binding relationship often needs to be updated, resulting in low efficiency. In addition, some environment objects are dynamically created and displayed during running. Therefore, a static binding manner also becomes unfeasible.

The second area-based playback manner is mainly configured for implementing large-scale environment audio playback, such as a background environment sound and music. However, such a playback control method is relatively coarse, and fine adjustment of the environment sound cannot be implemented. As content abundance of a large world scene increases, a fixed environment sound causes a problem of insufficient immersion.

In other words, no matter the environment audio is played in an object binding manner or an area playback manner, the environment audio in the scene is used as an independent unit, and is separately controlled and played. However, the environment sound is an audio design reflecting an overall environment effect. Different environment sounds affect and associate with each other. Existing solutions lack systematic and have serious shortcomings in playback performance and sound effects.

In addition, the environment sound may also be affected by another scene element, for example, a factor such as building occlusion and weather. The existing solutions lack scene interaction and lack immersion.

During implementation, all the existing solutions need manual intervention, cannot be automated, have very low integration efficiency, and are not suitable for an environment sound effect design of the large world.

To resolve the foregoing technical problem, in the embodiments of this application, the environment audio is first layered, and an overall environment audio includes a plurality of environment sound effect layers. Then, a correspondence between an environment audio of each environment sound effect layer and the environment object in the virtual scene is established, and distribution data of the environment object corresponding to the environment sound effect layer is exported. Next, expansion processing, compression, and encoding of position, three dimensions, and spatial information are performed on environment data based on an environment audio rendering requirement. Finally, a corresponding rendering parameter is extracted through the environment data, to control rendering and playback of the overall environment audio. It is implemented that the rendering and playback of the environment audio are driven based on data, and the environment audio being controlled and changed by a scene dynamic control factor is supported.

In this embodiment of this application, the environment audio is used as a system for overall design and playback, a hierarchical relationship and mutual influence of different environment audios are fully considered, and control and change of a dynamic environment factor is supported. The environment data may be configured for controlling a position signal of an audio playing range, and supporting extension of three-dimensional (3D) information, a direction, and a surrounding degree, and is configured for implementing a 3D audio effect, and effects such as spatial occlusion and reverberation that are integrated into a scene, thereby enhancing an overall immersion of the game. Finally, the solution drives the rendering and playback of the environment audio based on the environment data. Design parts of the environment audio may be fixed to different design templates. Rendering and playback of different environment audios are driven through the environment data of the virtual scene, so that automation of the environment audio of the virtual scene is implemented, thereby greatly improving development efficiency of a virtual interface (for example, a game).

In the embodiments of this application, an environment audio processing method is introduced through a game scene, but the embodiments of this application are not limited to the game scene, and any scene in which the environment audio needs to be rendered and played falls within the protection scope of the embodiments of this application.

Specifically, in the embodiments of this application, an overall environment sound system includes four parts: an environment audio design module 101, an environment object editing module 102, an environment data processing module 103, and an environment audio rendering module 104, as shown in FIG. 1B.

Firstly, overall design of an environment sound is performed through the environment audio design module 101, including design of an environment sound structure and design of sound effect content.

The design of an environment sound structure means that layered design of the environment audio is performed based on a type to which an environment belongs (an environment type for short), to obtain an environment sound effect layer corresponding to each environment type, and select a driving mode in which environment data of each environment sound effect layer is rendered and played, and output the content to a sound effect configuration file.

The design of sound effect content refers to design of an environment sound effect event and sound effect content corresponding to each environment sound effect layer. This part may be implemented through third-party sound effect design software, and a corresponding sound effect resource is exported.

Then, the environment object in each environment sound effect layer is selected through the environment object editing module 102, to perform audio setting, to form data (environment data for short) of the environment object, and then the environment data corresponding to each environment sound effect layer is exported. For example, the environment object editing module 102 is a game editor. The environment data exported for the environment object is classified into three types: point cloud data exported for a point-distributed environment object, area bitmap data exported fora limited-area distributed environment object, and overall bitmap data exported for a continuously distributed environment object.

The environment data processing module 103 is configured to extend, merge, and encode (including compression processing) the exported environment data, and output encoded environment data, each environment sound effect layer corresponding to one piece of encoded environment data. A function of the environment data processing module 103 is to integrate the environment data, reduce a storage size of data, and facilitate quick access to data during running of software.

Finally, the environment audio rendering module 104 reads the sound effect configuration file, loads the encoded environment data, to obtain rendered environment audio data, and then inputs the rendered environment audio data to a third-party audio middleware 105. The rendered environment audio data is played through an audio processing pipeline in combination with a game client 106. The game client 106 includes factors such as a scene, coordinates, and a dynamic environment. A function of the environment audio rendering module 104 is to implement initialization of an environment audio module, control playback management of a sound effect resource based on the environment data, and simultaneously render an audio effect.

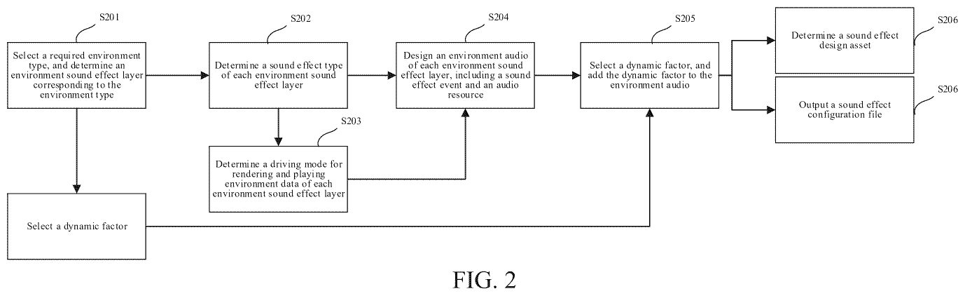

As shown in FIG. 2, main operations implemented by an environment audio design module 204 include the following operations.

S201: Select a required environment type, and determine an environment sound effect layer corresponding to the environment type.

S202: Determine a sound effect type of each environment sound effect layer.

S203: Determine a driving mode in which environment data of each environment sound effect layer is rendered and played.

S204: Design an environment audio of each environment sound effect layer based on the sound effect type and the driving mode of each environment sound effect layer, including an environment sound effect event and an audio resource, as sound effect content.

S205: Select a dynamic control factor based on the environment type, and add the dynamic control factor to the environment audio, so as to control an attribute of an environment sound effect to change.

S206: Determine a sound effect design asset, and output a sound effect configuration file.

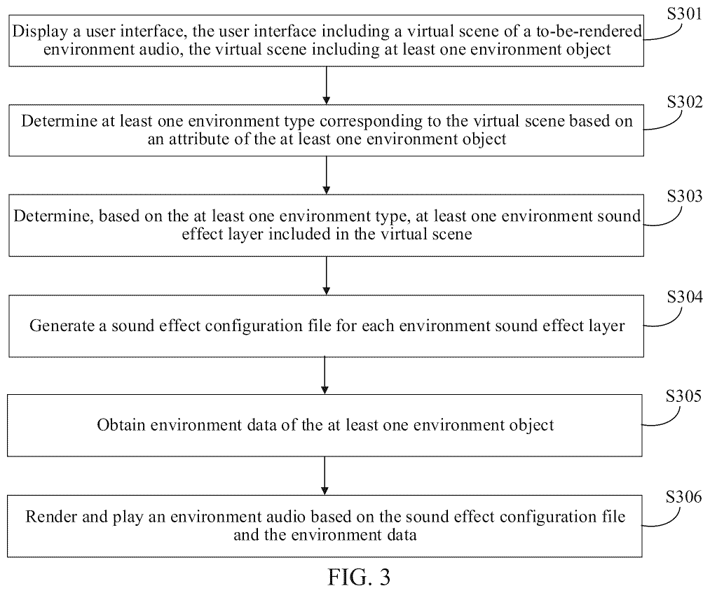

The environment audio processing method in the embodiments of this application is described below through specific implementations with reference to the accompanying drawings. The environment audio processing method is performed by the electronic device, for example, performed by the terminal device 10 in FIG. 1, or performed by both the terminal device 10 and the server 20. As shown in FIG. 3, the method includes the following operations.

Operation S301: Display a user interface, the user interface including a virtual scene of a to-be-rendered environment audio, the virtual scene including at least one environment object.

In this embodiment of this application, after the client runs, the user interface, for example, a game interface, is displayed. The virtual scene may be an environment sound scene of a current to-be-rendered and played environment audio, or may be an environment sound effect scene in which a target object is currently located. For example, for a game scene, the virtual scene may be an environment sound effect scene in which the virtual object controlled by a game player is currently located.

Operation S302: Determine at least one environment type corresponding to the virtual scene based on an attribute of the at least one environment object.

In this embodiment of this application, a virtual scene may include at least one environment type. Specifically, division is performed based on whether sound effect content expressed by environment objects included in the virtual scene is the same.

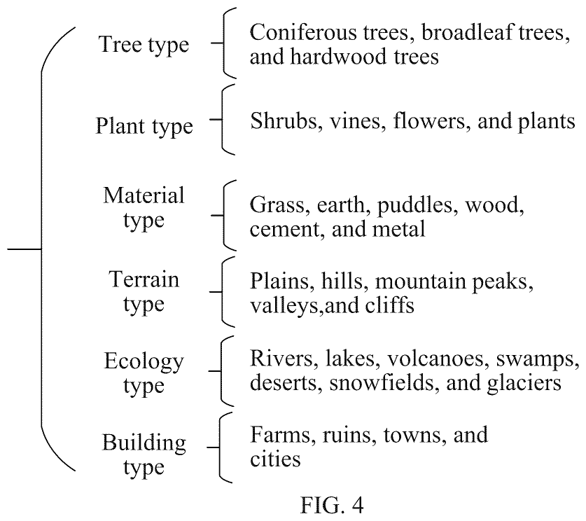

For example, the at least one environment type may include: a tree type, a plant type, a material type, a terrain type, an ecology type, or a building type, as specifically shown in FIG. 4.

Operation S303: Determine, based on the at least one environment type, at least one environment sound effect layer included in the virtual scene.

Each environment sound effect layer corresponds to one environment type. In other words, the virtual scene includes at least one environment sound effect layer, and one environment sound effect layer corresponds to one environment type.

For example, the virtual scene may include 4 environment sound effect layers, and environment types respectively corresponding to the environment sound effect layers are: the tree type, the plant type, the material type, and the terrain type.

Operation S304: Generate a sound effect configuration file for each environment sound effect layer.

In this embodiment of this application, the sound effect configuration file corresponding to each environment sound effect layer is obtained based on a first mapping relationship. The first mapping relationship includes a correspondence between each of a plurality of environment sound effect layers and a sound effect configuration file corresponding to the environment sound effect layer.

Specifically, in this embodiment of this application, the sound effect configuration file corresponding to each environment sound effect layer may be pre-configured, namely, the foregoing first mapping relationship is obtained. After the virtual scene is determined, the plurality of environment sound effect layers included in the virtual scene are determined, and the sound effect configuration file corresponding to each environment sound effect layer is determined.

As the foregoing example, audio configuration files of environment sound effect layers respectively corresponding to the tree type, the plant type, the material type, the terrain type, the ecology type, and the building type may be pre-configured. After it is determined that the virtual scene includes the environment sound effect layers respectively corresponding to the tree type, the plant type, the material type, and the terrain type, the sound effect configuration files corresponding to the four environment sound effect layers are determined based on the mapping relationship shown in the foregoing embodiment.

Operation S305: Obtain environment data of the at least one environment object.

In this embodiment of this application, the environment data corresponding to each environment object in the virtual scene is obtained. In other words, the environment data of the virtual scene is obtained.

The environment data of the virtual scene may be obtained in real time. In other words, after the virtual scene of the to-be-rendered and played environment audio is determined, the environment data corresponding to each environment object in the virtual scene is obtained in real time. Alternatively, the environment data of the virtual scene may be obtained and stored in advance. Then, when rendering and playback of the environment audio needs to be performed on the virtual scene, the environment data of the stored virtual scene is obtained.

Operation S306: Render and play an environment audio based on the sound effect configuration file and the environment data.

In this embodiment of this application, after the sound effect configuration file corresponding to each environment sound effect layer in the virtual scene is obtained, the rendering and playback of the audio in the virtual scene may be controlled based on the sound effect configuration file and the environment data of the virtual scene.

Specifically, in this embodiment of this application, for a specific manner of determining the virtual scene in operation S301, reference may be made to this embodiment of this application, and any manner of determining the virtual scene in the related art may also be covered, which is not limited in this embodiment of this application.

Specifically, in operation S302, the determining at least one environment type corresponding to the virtual scene based on an attribute of the at least one environment object may specifically include: determining, from a plurality of candidate object types, a target object type to which each environment object belongs; and determining, as the at least one environment type, at least one target object type to which each environment object belongs.

In other words, a one-to-one correspondence exists between the environment type and the object type. In other words, the plurality of candidate object types may include: the tree type, the plant type, the material type, the terrain type, the ecology type, and the building type. In this embodiment of this application, after each environment object included in the virtual scene is determined, the target object type corresponding to each environment object, namely, the at least one environment type included in the virtual scene, is determined.

Specifically, for an environment object whose sound need to be rendered in the virtual scene, a target object type to which the environment object belongs is determined based on whether the same sound effect content is designed for the environment object.

For example, as shown in FIG. 4,
1) an object type corresponding to a coniferous tree, a broadleaf tree, and a hardwood tree is a tree type;
2) an object type corresponding to a shrub, a vine, a flower, and a plant is a plant type;
3) an object type corresponding to a lawn, an earth, a puddle, a wood, a cement, and a metal is a material type;
4) an object type corresponding to a plain, a hill, a mountain peak, a valley, and a cliff is a terrain type;
5) an object type corresponding to a river, a lake, a volcano, a swamp, a desert, a snowfield, and a glacier is an ecology type; and
6) an object type corresponding to a farm, a ruin, a town, and a city is a building type.

If the virtual scene includes the coniferous tree, the shrub, the vines, the lawn, and the plain, it is determined that corresponding object types are: the tree type, the plant type, the material type, and the terrain type. In other words, the at least one environment type included in the virtual scene is: the tree type, the plant type, the material type, and the terrain type.

Further, an association relationship exists between the environment type and the environment object. In operation S303, the determining, based on the at least one environment type, at least one environment sound effect layer included in the virtual scene may specifically include: determining the environment sound effect layer corresponding to the environment type depending on whether the same sound effect content is designed for the environment object in each environment type.

Specifically, to express environment types of the same sound effect content, the same sound effect layer is designed. In other words, one environment type may correspond to one environment sound effect layer or a plurality of environment sound effect layers.

An environment sound of each environment sound effect layer is independently designed for a sound effect. The environment sound of the plurality of environment sound effect layers entirely constitutes an environment atmosphere sound effect. A specific example is provided in FIG. 4, which is classified into six environment sound effect layers:
1) the tree type, including a coniferous tree, a broadleaf tree, and a hardwood tree, and forming an environment sound effect layer;
2) the plant type, including a shrub, a vine, a flower, and a plant, and forming an environment sound effect layer;
3) the material type, including a lawn, an earth, a puddle, a wood, a cement, and a metal, and forming an environment sound effect layer;
4) the terrain type, including a plain, a hill, a mountain peak, a valley, and a cliff, and forming an environment sound effect layer;
5) the ecology type, including a river, a lake, a volcano, a swamp, a desert, a snow, and a glacier, and forming an environment sound effect layer; and
6) the building type, including a farm, a ruin, a town, and a city, and forming an environment sound effect layer.

Further, after the at least one environment sound effect layer included in the virtual scene is determined, a sound effect configuration file is generated for each environment sound effect layer. For example, a sound effect configuration file corresponding to each environment sound effect layer is determined based on the mapping relationship between the environment sound effect layer and the sound effect configuration file.

In this embodiment of this application, the obtaining a sound effect configuration file corresponding to each environment sound effect layer based on a first mapping relationship includes any one of manner 1 and manner 2.

Manner 1: Obtain a scene sound effect configuration file corresponding to the virtual scene, the scene sound effect configuration file including the sound effect configuration file corresponding to each environment sound effect layer; and obtain the sound effect configuration file corresponding to each environment sound effect layer from the scene sound effect configuration file based on a preset first mapping relationship.

In other words, in a possible implementation, the scene sound effect configuration file corresponding to the virtual scene is pre-configured. For example, a scene configuration file 1 corresponding to a sound effect scene 1, a sound effect configuration file 2 corresponding to a sound effect scene 2, and a scene configuration file 3 corresponding to a sound effect scene 3 are pre-configured. If the virtual scene is the sound effect scene 1, the scene configuration file 1 is obtained.

Further, after the scene configuration file 1 is obtained, a sound effect configuration file corresponding to each environment sound effect layer in the sound effect scene 1 is determined based on the first mapping relationship.

Manner 2: Obtain an overall sound effect configuration file, the overall sound effect configuration file including a scene sound effect configuration file corresponding to each virtual scene; obtain the scene sound effect configuration file corresponding to the virtual scene from the overall sound effect configuration file; and obtain the sound effect configuration file corresponding to each environment sound effect layer from the scene sound effect configuration file based on a preset first mapping relationship.

In other words, in another possible implementation, the overall sound effect configuration file is pre-configured, and the overall sound effect configuration file includes the scene sound effect configuration file corresponding to each virtual scene. In this embodiment of this application, after the virtual scene is determined, the scene sound effect configuration file corresponding to the virtual scene is first determined from the overall sound effect configuration file, and then the sound effect configuration file corresponding to each environment sound effect layer is obtained from the scene sound effect configuration file based on the first mapping relationship.

In addition to the foregoing two possible manners, to save a storage space, only a corresponding sound effect configuration file may be pre-configured for each environment sound effect layer. In other words, the sound effect configuration file corresponding to each environment sound effect layer is pre-determined and stored, to obtain the foregoing first mapping relationship. Further, after the virtual scene is determined, environment sound effect layers that are specifically included in the virtual scene are determined, and then sound effect configuration files corresponding to these environment sound effect layers are further determined.

Further, each environment sound effect layer corresponds to an audio configuration file, and the audio configuration file includes at least one of the following: at least one of a sound effect type corresponding to the environment sound effect layer, an environment sound effect event, or a driving mode of the environment data, the environment sound effect event including at least one piece of sound effect content;

the driving mode being a manner of controlling playback of the environment audio through the environment data included in the environment sound effect layer;

a sound effect resource file, including at least one sound effect resource corresponding to each sound effect content; and

first dynamic control data, including a control parameter corresponding to the at least one piece of sound effect content.

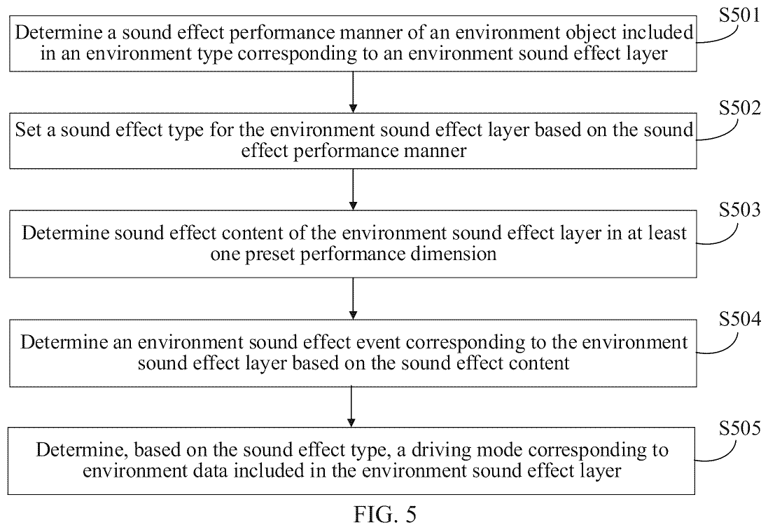

Specifically, if the audio configuration file includes the sound effect type corresponding to the environment sound effect layer, the environment sound effect event, and the driving mode of the environment data. A specific manner of generating the sound effect configuration file for each environment sound effect layer, as shown in FIG. 5, includes:

Operation S501: Determine a sound effect performance manner of the environment object included in the environment type corresponding to the environment sound effect layer.

In this embodiment of this application, an environment type corresponds to an environment sound effect layer. The sound effect performance manner of the environment object included in each environment type is determined, including: radiating outward by using a point as a center, radiating outward by using an area as a boundary, and tiling based on an entire background.

Operation S502: Set a sound effect type for the environment sound effect layer based on the sound effect performance manner.

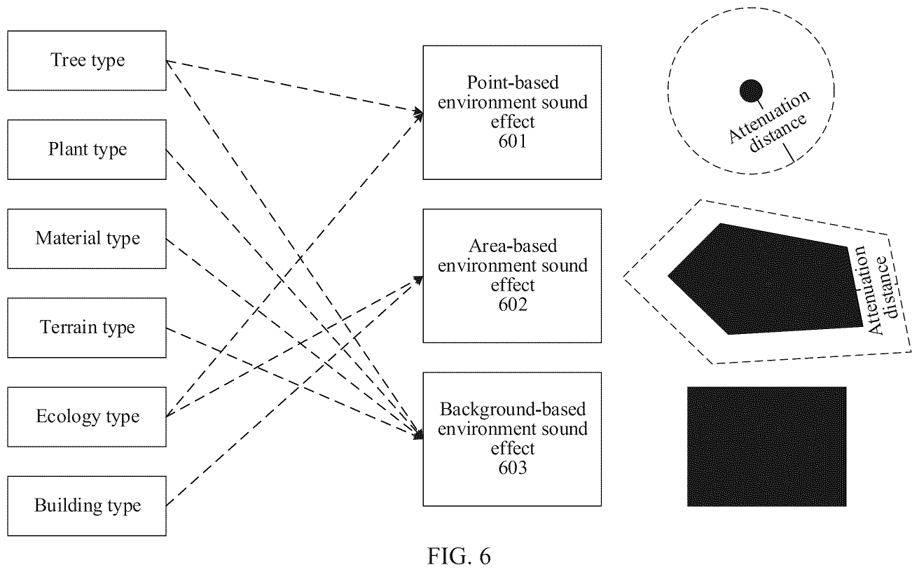

Specifically, based on the sound effect performance manner of the environment object, the environment sound effect layer may be classified into three sound effect types: a point-based environment sound effect, an area-based environment sound effect, and a background-based environment sound effect. As shown in FIG. 6,
1) a sound of a point-based environment sound effect 601 uses a point as a center, has a fixed playing range around a sound production point, and a volume of the sound attenuates with a distance.
2) A sound of an area-based environment sound effect 602 is bounded by an area, a sound is heard when approaching and entering the area, and a volume of the sound attenuates when exiting and leaving the area.
3) A background-based environment sound effect 603 has no fixed center or area range, and sounds heard at different positions may be fixed or changed.

Each environment sound effect layer may correspond to different environment sound effect types. The classification manner is not fixed, and is closely related to an environment sound form specifically expressed by the environment type.

For example, as shown in FIG. 6, the point-based environment sound effect 601 and the background-based environment sound effect 603 are set for an environment sound effect layer corresponding to the tree type, the background-based environment sound effect 603 is set for an environment sound effect layer corresponding to the plant type, the background-based environment sound effect 603 is set for an environment sound effect layer corresponding to a material type, the background-based environment sound effect 603 is set for an environment sound effect layer corresponding to the terrain type, the point-based environment sound effect 601 and the area-based environment sound effect 602 are set for an environment sound effect layer corresponding to the ecology type, and the area-based environment sound effect 602 is set for an environment sound effect layer corresponding to the building type.

Operation S503: Determine sound effect content of the environment sound effect layer in at least one preset performance dimension.

In this embodiment of this application, the environment sound effect is a memory association generated by an environment, and is expressed through a sound. Therefore, when designing each environment sound effect event, three dimensions of biological performance, weather performance, and atmosphere performance can be configured for setting respective sound effect content.

For example, sound effect content set for the environment sound effect layer corresponding to the plant type is as follows.
1) In the biological performance dimension, a shape of a plant and a biological information sound effect generated by an inquilinous insect is mainly expressed.
2) In the weather performance dimension, an effect caused by a weather change is expressed, such as a sound effect of rainwater hitting leaves or wind blowing branches.
3) In the atmosphere performance dimension, performance of some artistic effects, for example, atmosphere sound effects such as tense and horrible is included.

As a specific example given in Table 1 below, the environment sound effect layer corresponding to the tree type provides different sound effect content in 3 performance dimensions, which are specifically identified through keywords.

TABLE 1

| | | Keywords of sound |
|---|---|---|
| Environment type | Performance dimension | effect content |
| Tree type | Biological performance | Woodpecker |
| | | Sparrow |
| | Weather performance | Rainwater falling |
| | | on leaves |
| | | Blowing on leaves |
| | | Defoliation |
| | | Branches sway |
| | Atmosphere performance | Gloomy |

Operation S504: Determine an environment sound effect event corresponding to the environment sound effect layer based on the sound effect content.

The environment sound effect event refers to an event triggering playback of sound effect content in at least one preset performance dimension.

In this embodiment of this application, to ensure natural listening during sound playback, each sound effect content includes a plurality of audio resources. For example, the audio resource is specifically an audio material. Each time the environment audio is played, an audio material may be randomly selected for playback. The audio resource table is configured for describing an audio material of each sound effect content, as shown in Table 2.

TABLE 2

| Keywords of sound effect content | Audio material |
|---|---|
| Woodpecker | Woodpecker audio 0 |
| | Woodpecker audio 1 |
| | Woodpecker audio 2 |
| Sparrow | Sparrow audio 0 |
| | Sparrow audio 1 |
| | Sparrow audio 2 |
| | Sparrow audio 3 |

Operation S505: Determine, based on the sound effect type, a driving mode corresponding to the environment data included in the environment sound effect layer.

In this embodiment of this application, an environment sound system relies on environment data to drive rendering and playback of the environment audio. The driving mode is determined. In other words, how each environment sound effect layer uses the environment data of the layer to control the rendering and playback of the environment audio is determined.

It may be learned from the foregoing embodiments that each environment sound effect layer corresponds to at least one sound effect type. After the sound effect type corresponding to the environment sound effect layer is determined, the driving mode corresponding to the environment sound effect layer may be determined based on a second mapping relationship. One sound effect type corresponds to at least one mode.

The second mapping relationship includes mapping relationships between a plurality of sound effect types and corresponding driving modes.

Specifically, in this embodiments of this application, the determining, based on the sound effect type, a driving mode corresponding to the environment data included in the environment sound effect layer specifically includes: determining, based on the sound effect type, at least one driving mode supported by the environment sound effect layer; determining each data type of the environment data; and determining, from the at least one driving mode, a driving mode corresponding to each data type as the driving mode corresponding to the environment sound effect layer based on a mapping relationship between the data type and the driving mode.

In this embodiment of this application, different types of environment sound effect layers correspondingly support different driving modes. Based on an existing environment audio playback mode, an environment sound effect layer of the point-based environment sound effect may support object driven and group driven, an environment sound effect layer of the area-based environment sound effect may support area 2D driven and area 3D driven, and an environment sound effect layer of the background-based environment sound effect may support proportional driven.

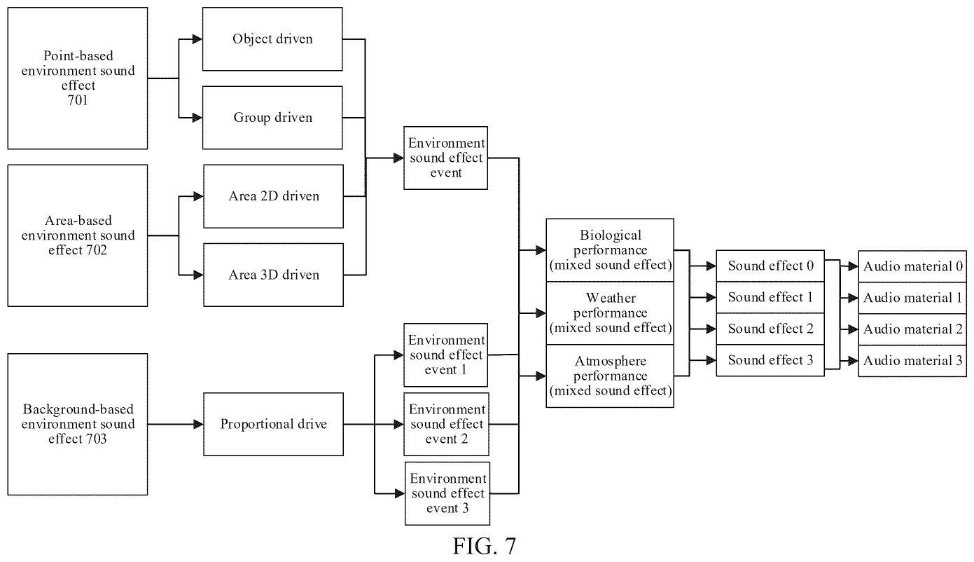

Further, types of environment data of environment objects included in the same environment sound effect layer may be different, and driving modes supported by different types of environment data are also different. Details are shown in FIG. 7.

### 1) Sound Effect Type: Point-Based Environment Sound Effect 701

### 1.1) Driving Mode: Object Driven

Data type: single-point object data, including a position and a behavior of an object.
Audio playback: triggering and controlling corresponding audio playback at a specified position based on the position and the behavior of the object.

### 1.2) Driving Mode: Group Driven

Data type: multi-point object data, one object includes a plurality of position information.
Audio playback: determining to trigger and control corresponding audio playback at a particular position based on the plurality of position information.

### 2) Sound Effect Type: Area-Based Environment Sound Effect 702

### 2.1) Driving Mode: Area 2D Driven

Data type: area data, detecting a type of a current area in which the area data is located.
Audio playback: a corresponding type of audio playback is triggered based on the type of the current area in which the area data is located, and the audio playback ends when the current area is left.

### 2.2) Driving Mode: Area 3D Driven

Data type: area data, detecting a type of a current area in which the area data is located, and a distance between a current position in which the area data is located and the area after leaving the area.
Audio playback: triggering playback of a corresponding type of sound effect based on the type of the current area in which the area data is located, and controlling volume attenuation and a playback position based on the distance between the current position in which the area data is located and the area.

### 3) Background-Based Environment Sound Effect 703

### 3.1) Driving Mode: Proportional Driven

Data type: ratio data, collecting statistics on a ratio of various environment types in a specific range around a current position.
Audio playback: triggering audio playback of the plurality of sound effect types based on a ratio of the environment type.

For the point-based environment sound effect and the area-based environment sound effect, different driving modes correspond to the same environment type, thereby corresponding to the same environment sound effect event.

However, the background-based environment sound effect corresponds to a plurality of environment types. Therefore, a plurality of environment sound effect events are driven. For example, in FIG. 7, three environment sound effect events 1, 2, and 3 are listed.

When the background-based environment sound effect is designed, a sound effect needs to be designed for each environment type, and one environment type corresponds to one environment sound effect event. In this embodiment of this application, for details of a design manner for one environment sound effect event, reference is made to the foregoing embodiments. Details are not described again.

Further, it may be learned from the foregoing embodiment that the audio configuration file corresponding to each environment sound effect layer may further include first dynamic control data. The first dynamic control data includes a plurality of dynamic control factors.

A real audio playback scene may include a plurality of dynamic control factors. For example, in a game scene, the environment sound is supported to change with the dynamic control factor, bringing more immersion to game experience. To support dynamic adjustment of the environment sound effect, necessary dynamic control factors need to be provided according to an actual case, as shown in Table 3.

In addition, in the game scene, a game state and a behavior of a protagonist may also be used as the dynamic control factors. The ratios of the plurality of environment types that are obtained through calculation during ratio driving may also be used as a control factor for control.

TABLE 3

| Dynamic | | |
|---|---|---|
| control | | |
| factors | Range | Remark |
| Time | 0-24 | Time temperature difference is determined by |
| | | a time factor |
| Temperature | −40-40 | Show temperature changes brought by different |
| | | areas |
| Season | 0-3 | Spring, summer, autumn, and winter |
| Rainfall | 0-100 | 0 means no rain, and 100 means a maximum |
| | | rainfall |
| Wind force | 0-100 | 0 means no wind, and 100 means a maximum |
| | | wind force |
| Sunlight | 0-100 | 0 means a gloomy day, 50 means a cloudy, and |
| | | 100 means sunny day |
| Altitude | 0-100 | 0 means a low altitude, and 100 means a |
| | | high altitude |
| Visibility | 0-100 | 0 means field of view is very poor, and |
| | | 100 means field of view is very good |

Impact of the dynamic control factor on design of the sound effect is mainly implemented by changing an attribute of the sound effect, such as a volume, a playback frequency, a trigger probability, and a rendering effect. A specific attribute may be selected based on an actual situation.

As shown in Table 4, four dynamic control factors of time, temperature, rainfall, and wind force are defined. Different values are set for volumes of different sound effects, as shown in Table 4. When one of the dynamic control factors changes in a game process, a playback volume is adjusted or stopped based on a value in the table.

TABLE 4

| Keywords of sound | | | | |
|---|---|---|---|---|
| effect content | Time | Temperature | Rainfall | Wind force |
| Woodpecker | 9-16 | 30-40 | 0 | 0-1 |
| Sparrow | 12-18 | 20-35 | 0-1 | 0-1 |
| Rainwater falling | — | — | 1-5 | — |
| on leaves | | | | |
| Blowing on leaves | — | — | — | 3-10 |
| Defoliation | — | — | — | 1-3 |
| Branches sway | — | — | — | 5-10 |
| Gloomy | 0-5, 20-24 | — | — | 0-5 |

Further, in the foregoing embodiment, at least one of the sound effect type of the environment sound effect layer, the environment sound effect event, or the driving mode of the environment data, and at least one of the sound effect resource file or the first dynamic control data may be determined. In addition, the audio configuration file corresponding to each environment sound effect layer is generated based on the information. In other words, the sound effect configuration file corresponding to each environment sound effect layer is obtained in advance.

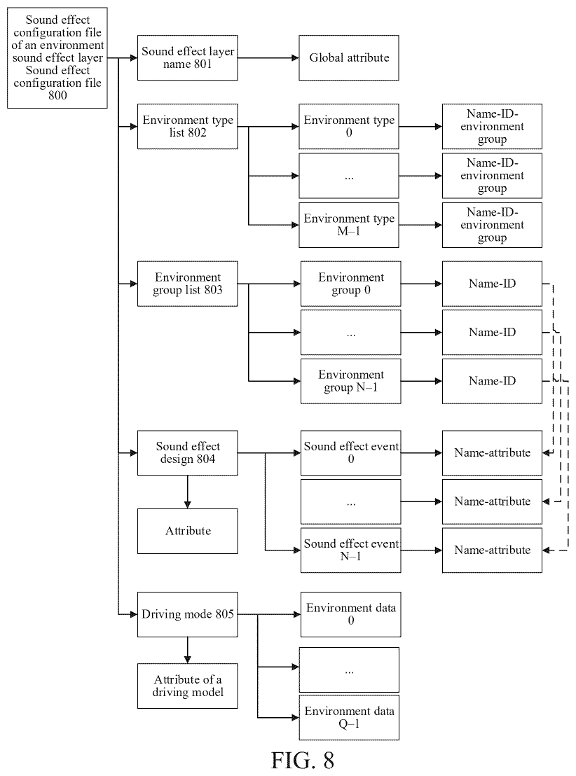

Specifically, the audio configuration file describes specific information about design and playback of each environment sound effect layer, and is used by the environment sound system to initialize a rendering structure of the environment sound effect layer, as shown in FIG. 8.

A plurality of environment types exist. Sometimes similar environment types are defined as an environment type group. In other words, an identifier (ID) of each environment type is different, and the environment types have a common environment group if belonging to the same environment group. Each environment group cites the same sound effect design, and each environment type ID is configured for distinguishing an export environment type.

Specifically, as shown in FIG. 8, a sound effect configuration file 800 corresponding to an environment sound effect layer may include:
1) a sound effect layer name 801 and a global attribute;
2) an environment type list 802, for example, an environment type 0, . . . , and an environment type M-1, and a name and an ID corresponding to each environment type, and a mapping relationship “name-ID-environment group” between the environment types;
3) an environment group list 803, for example, an environment group 0, . . . , and an environment group N-1, and a mapping relationship “name-ID” between an environment group name and an ID;
4) a sound effect design 804, including an attribute of the sound effect design, an environment sound effect event 0, . . . , and an environment sound effect event N-1, and a mapping relationship “name-attribute” between a name and an attribute corresponding to each environment sound effect event; and
5) a driving mode 805, including an attribute of the driving mode, environment data 0, . . . , and environment data Q-1.

Further, in the foregoing embodiment, a manner of generating an audio configuration file corresponding to any environment sound effect layer is described. After the virtual scene is obtained, a sound effect configuration file corresponding to each environment sound effect layer in the virtual scene is obtained.

Further, when rendering and playing the audio in the virtual scene, the environment data of the at least one environment object needs to be obtained.

Specifically, the obtaining the environment data of the at least one environment object may specifically include: obtaining a distribution range of each environment object; determining a distribution type of each environment object based on the distribution range; and obtaining environment data of each environment object based on the distribution type.

In this embodiment of this application, environment objects in the virtual scene may be classified into three environment distribution types based on distribution ranges thereof:
1) a point distribution type: one object is expressed as one point, a position of each object corresponds to one coordinate, and an environment object belonging to the point distribution type is, for example, an independent environment object such as a plant or an animal;
2) a limited area distribution type: a distribution area range of the environment object is limited. For example, if an area range occupied by an object is within a preset range, it may be considered that the object is the object of the limited area type, such as an ecological area such as a river or a volcano; and
3) a continuous distribution type: environment objects are continuously distributed in the virtual scene, and environment objects under each environment type occupy a specific range, for example, the foregoing environment objects of the terrain type and the material type.

Specifically, in this embodiment of this application, an environment distribution type corresponding to one environment object is that the distribution type is the point distribution type, the limited area distribution type, or the continuous distribution type. The obtaining environment data of each environment object based on the distribution type may specifically include:
obtaining spatial position information of the environment object as the environment data of the environment object if the distribution type of the environment object belongs to the point distribution type;
meshing a spatial area in which the environment object is located if the distribution type of the environment object belongs to the limited area distribution type, determining, from an obtained mesh, a mesh that overlaps with the environment object, and using position information of the overlapping mesh as the environment data of the environment object; and
obtaining plane bitmap data of the environment object as the environment data of the environment object if the distribution type of the environment object belongs to the continuous distribution type.

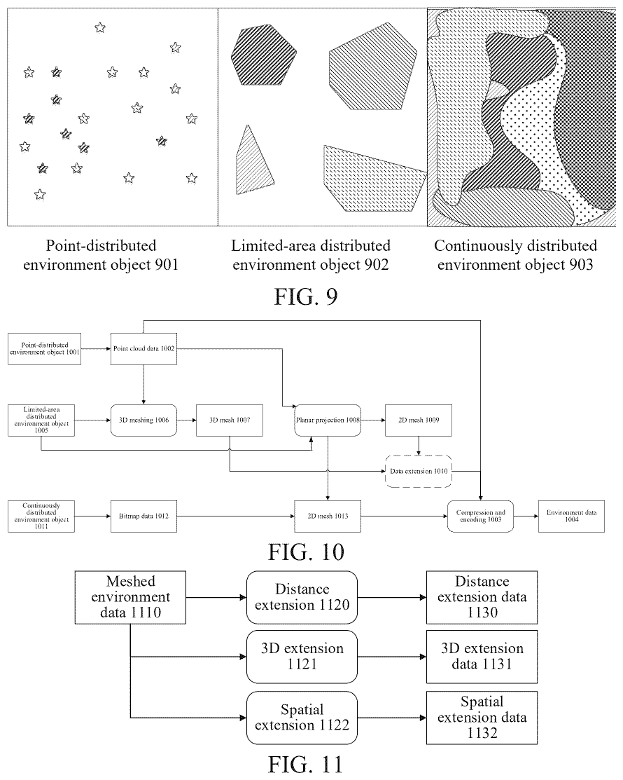

As shown in FIG. 9, in this embodiment of this application, for a point-distributed environment object 901, exported environment data is spatial position information of each environment object, and the data is also referred to as point cloud data.

For a limited-area distributed environment object 902, a spatial area of the limited area distribution environment object is first meshed, then whether each mesh overlaps with the environment object is determined, and position information of overlapped meshes, for example, spatial position information of a center point and a radius of the mesh or four vertexes of the mesh, is stored as mesh data of the mesh. In other words, export of the environment data is completed.

In this embodiment of this application, for the limited-area distributed environment object, if environment data of the object is located in a two-dimensional (2D) plane, the environment data is represented through a 2D array. If the environment data of the object is located in a 3D space, the environment data is represented through 3D data.

For a continuously distributed environment object 903, plane bitmap data thereof may be exported. In other words, a continuously distributed plane is divided into a plurality of lattices, and each lattice is identified through a bitmap.

In this embodiment of this application, each environment sound effect layer may simultaneously include different distribution types of environment objects. When these different distribution types of environment objects belong to the same environment sound effect layer, environment data exported by the environment objects needs to be integrated into the same type of data format.

In this embodiment of this application, for each environment sound effect layer, after the corresponding environment data is obtained based on the environment distribution type corresponding to each environment object, the method may further include:
compressing and encoding environment data of a point-distributed environment object if the environment sound effect layer only includes the point-distributed environment object;
compressing environment data of a limited-area distributed environment object if the environment sound effect layer includes only the limited-area distributed environment object;
compressing environment data of a continuously distributed environment object if the environment sound effect layer includes only the continuously distributed environment object; and
directly compressing and encoding environment data of each environment object if the environment sound effect layer includes at least two of the point-distributed environment object, the limited-area distributed environment object, or the continuously distributed environment object.

When a uniform data format is needed, if the environment sound effect layer includes at least two of the point-distributed environment object, the limited-area distributed environment object, or the continuously distributed environment object, meshing processing is performed on the environment data of each environment object, and environment data obtained after the meshing processing is compressed and encoded. The meshing processing is 3D meshing processing or 2D meshing processing.

Specifically, FIG. 10 provides a possible implementation of a processing manner of data of different environment object types, and is not intended to limit this embodiment of this application.

If only a point-distributed environment object 1001 exists in an environment sound effect layer, point cloud data may be exported, compression and encoding 1003 are directly performed, and environment data 1004 is outputted.

If the point-distributed environment object 1001 and a limited-area distributed environment object 1005 simultaneously exist and 3D information is considered, the two environment objects jointly perform 3D meshing processing 1006, then perform the compression and encoding 1003, and output environment data 1004. If only 2D information is considered, planar projection 1008 is performed on the two environment objects, the 2D information is converted into a 2D mesh 1009, then the compression and encoding 1003 is performed, and the environment data 1004 is outputted.

If only a continuously distributed environment object 1011 exists in the environment sound effect layer, bitmap data 1012 may be exported. The bitmap data 1012 is converted based on precision of a 2D mesh 1013, then the compression and encoding 1003 is performed, and the environment data 1004 is outputted.

In addition to the continuously distributed environment object 1011, another type of environment object (the point-distributed environment object 1001 or the limited-area distributed environment object 1005) also needs to be converted into the 2D mesh 1013, then the compression and encoding 1003 is performed, and the environment data 1004 is outputted. In this way, merging of various types of data converted into the 2D mesh is implemented.

Further, the directly exported environment data has only spatial position information. If more rendering effects need to be implemented, data extension 1010 is performed.

If the environment sound effect layer includes the limited-area distributed environment object 1005, after the meshing processing is performed on the environment data of the limited-area distributed environment object 1005, the method may further include: performing data extension on the meshed environment data of the limited-area distributed environment object 1005, to obtain at least one of distance extended data, 3D extended data, or spatial extended data.

As shown in FIG. 10, the data expansion 1010 is performed on data of a 3D mesh 1007 or data of a 2D mesh 1009, so as to calculate a distribution distance of an area, 3D information (such as an orientation and a surrounding degree), and spatial information (an occlusion or reverberation type), to support implementation of more rendering effects.

As shown in FIG. 11, a plurality of extension processing, including a distance extension 1120, a 3D extension 1121, and a spatial extension 1122, may be simultaneously performed on meshed environment data 1110 of the limited-area distributed environment object, to obtain distance extended data 1130, 3D extended data 1131, and spatial extended data 1132. Each piece of extended data is separately stored, and whether to load the extended data to implement a corresponding rendering calculation and effect may be determined based on a specific situation during running.

Further, after the sound effect configuration file corresponding to each environment sound effect layer in the virtual scene and the environment data corresponding to the environment object are obtained through the foregoing embodiments, the rendering and playing an environment audio based on the sound effect configuration file and the environment data may specifically include: determining a sound effect control parameter of each environment object based on the environment data; determining a driving mode of each environment data from the sound effect configuration file based on a data type of the environment data of each environment object; obtaining a sound effect resource file, the sound effect resource file including at least one sound effect resource corresponding to each sound effect content; and rendering and playing the at least one sound effect resource based on the driving mode and the sound effect control parameter.

Specifically, in this embodiment of this application, the environment audio is driven to render and play based on the environment data, which is mainly implemented by calculating information needed for rendering and playing through the environment data, and then controlling the audio playback. Information needed to control the rendering and playback of the environment audio may be divided into three categories.
1) Position information: it is determined that whether corresponding environment audio is played or stopped based on a position at which the environment data is distributed, and a playback distance may also be calculated, and is configured for controlling an attenuation degree of a volume. The position information may be directly exported without requiring expansion processing.
2) 3D information: 3D listening information such as an energy distribution and a surrounding degree of an environment audio is dynamically determined based on a position at which environment data is distributed, to control rendering and playback of the environment audio. The 3D information needs to be detected and obtained by relying on extended data exported by the data extension.
3) Spatial information: A spatial effect of environment sound is implemented by detecting spatial effects such as occlusion, reverberation, and diffraction between a playback position and environment data based on spatial distribution information of the environment data. The spatial information needs to be calculated and obtained by relying on the data extension to export corresponding extended data.

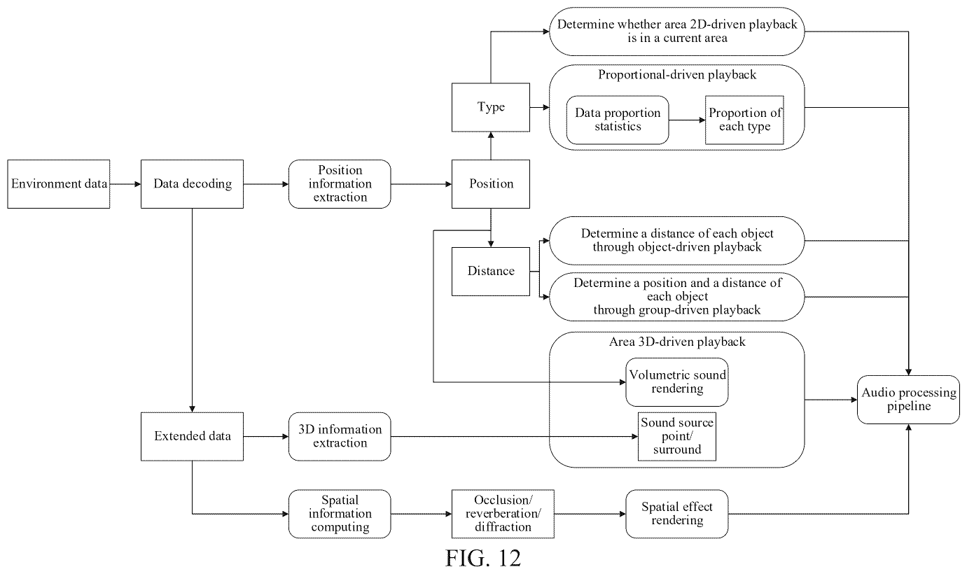

As shown in FIG. 12, after the environment data is decoded, the position information may be directly extracted. After the decoded environment data is extended, the 3D information can be extracted, and the spatial information can be calculated.

Based on a type of the position information, area 2D-driven playback and proportional driving playback may be implemented. Based on a distance in the position information, the object drive playback, the group driven playback, and area 3D-driven playback may be implemented. Based on the position information, the area 3D-driven playback may further be implemented through a volumetric sound rendering method.

Based on the 3D information, the area 3D-driven playback may be implemented through a sound source point/surround method.

Further, for the extended data, 3D information extraction may also be performed on the extended data, to implement the 3D-driven playback. In addition, for the extended data, spatial effects such as occlusion, reverberation, and diffraction between the playback position and the environment data may also be detected by performing spatial information computing on the extended data, to implement rendering of the spatial effect. Further, various driving playback and rendered spatial effects are superimposed through an audio processing pipeline, to implement rendering and playback of the audio.

Further, during rendering and playing the audio, at least one sound effect resource corresponding to each sound effect content in the sound effect resource file is rendered and played, to control rendering and playback of a virtual scene audio.

In this embodiment of this application, the audio resource file corresponding to the audio configuration file of each environment sound effect layer may be stored in an audio configuration file corresponding to the layer, and is obtained from the audio configuration file during rendering and playing the audio. If the audio configuration file does not include the audio resource file corresponding to the environment sound effect layer, a sound effect resource file corresponding to the audio configuration file of each environment sound effect layer needs to be obtained.

Further, based on the foregoing embodiment, the method may further include: obtaining second dynamic control factor control data, the second dynamic control factor control data including a control parameter corresponding to at least one piece of sound effect content; and. In other words, the rendering and playing an environment audio based on the sound effect configuration file and the environment data may specifically include: rendering and playing the environment audio through the second dynamic control factor control data based on the sound effect configuration file and the environment data.

In this embodiment of this application, no matter whether the sound effect configuration file includes first dynamic control factor control data, when rendering and playback of the sound effect in the virtual scene are controlled, an attribute of the environment sound may further be controlled to change through the second dynamic control factor control parameter.

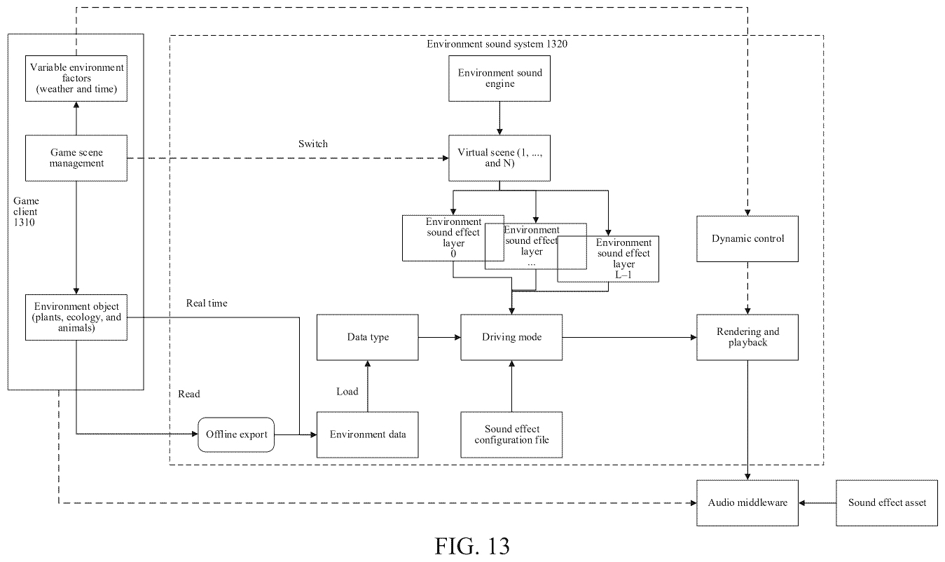

An environment audio processing method is described below through a specific example, which is applied to an environment audio processing system. As shown in FIG. 13, a description is provided by using a game scene as an example. The environment audio processing system includes a game client 1310 and an environment sound system 1320. The environment sound system 1320 may be located in a client, or may be located in a server.

Specifically, in the environment sound system 1320, an environment sound engine manages a virtual scene, and performs virtual scene switching based on a current game scene (in other words, game scene management in the game client controls switching of the virtual scene). An environment sound effect of one virtual scene (1, . . . , N) includes a plurality of environment sound effect layers (an environment sound effect layer 0, . . . , and an environment sound effect layer L-1). Each environment sound effect layer has an environment sound effect structure and a driving mode. The environment sound effect structure is described through a sound effect configuration file, and includes a relationship with a sound effect asset and environment data.

The driving mode of the environment sound effect layer is determined based on the audio configuration file, and environment data corresponding to the data type is loaded, which are configured for rendering and playing environment audio. The environment data may be obtained by the game client 1310 in real time from environment data (for example, a plant, an ecology, and an animal) of the environment object, or may read the environment object, and export the environment data corresponding to the environment object from offline data.

Further, a third-party audio middleware is responsible for a processing pipeline of sound. The audio middleware loads a designed sound effect asset, and controls corresponding environment audio to be played or stopped based on an instruction of the environment sound system 1320. In addition, in an environment sound effect processing process, a rendering effect of the audio is processed based on the environment sound system 1320. A variable environment factor in a game dynamically changes an attribute of an environment sound. The variable environment factor may be obtained by the game client. For example, the variable environment factor may include weather, time, and the like.

Further, in this embodiment of this application, in the manner shown in the foregoing embodiments, the corresponding audio configuration files can be obtained based on each environment sound effect layer included in the virtual scene of the to-be-rendered environment audio, and then rendering and playback of the environment audio are driven based on the data. A specific scene object or object does not need to be bound. The specific scene object or object is highly decoupled from a design of the game scene, thereby optimizing an environment sound effect development workflow.

In this embodiment of this application, using the game scene as an example, a sound effect design process can be templatized by formulating a set of operations and specifications of environment sound effect design, and various types of environment sound effects can be rapidly supported to be automatically generated, thereby greatly improving game development efficiency. An environment sound effect is designed as a whole, mutual impact of the environment sound effects is fully considered, and a game dynamic control factor is introduced to control a dynamic change of the environment sound effect, thereby improving immersive experience of the game.

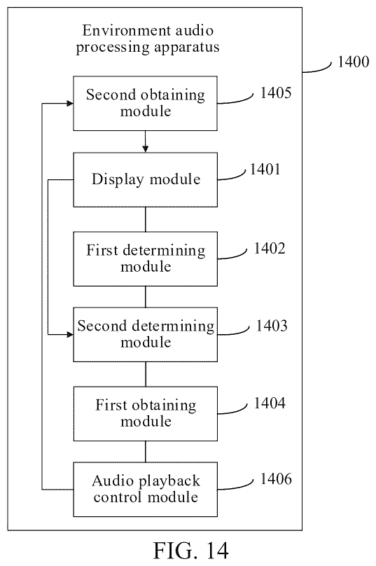

Based on a principle the same as that of the environment audio rendering and playback method provided in this application, an embodiment of this application further provides an environment audio processing apparatus. The apparatus may be implemented as any electronic device. As shown in FIG. 14, the environment audio processing apparatus 1400 may include a display module 1401, a first determining module 1402, a second determining module 1403, a first obtaining module 1404, a second obtaining module 1405, and an audio playback control module 1406.

The display module 1401 is configured to display a user interface, the user interface including a virtual scene of a to-be-rendered environment audio, the virtual scene including at least one environment object.

The first determining module 1402 is configured to determine at least one environment type corresponding to the virtual scene based on an attribute of the at least one environment object.

The second determining module 1403 is configured to determine, based on the at least one environment type, at least one environment sound effect layer included in the virtual scene, each environment sound effect layer corresponding to one environment type.

The first obtaining module 1404 is configured to generate a sound effect configuration file for each environment sound effect layer.

The second obtaining module 1405 is configured to obtain environment data of the at least one environment object.

The audio playback control module 1406 is configured to render and play an environment audio based on the sound effect configuration file and the environment data.

Specifically, when determining at least one environment type corresponding to the virtual scene based on an attribute of the at least one environment object, the first determining module 1402 is specifically configured to:
determine, from a plurality of candidate object types, a target object type to which each environment object belongs; and
determine, as the at least one environment type, at least one target object type to which each environment object belongs.

Specifically, the audio configuration file includes at least one of the following:
at least one of a sound effect type corresponding to the environment sound effect layer, an environment sound effect event, or a driving mode of the environment data,
the environment sound effect event including at least one piece of sound effect content;
the driving mode being a manner of controlling playback of the environment audio through the environment data included in the environment sound effect layer; a sound effect resource file, including at least one sound effect resource corresponding to each sound effect content; and
first dynamic control data, including a control parameter corresponding to the at least one piece of sound effect content.

In another possible implementation of this embodiment of this application, the first obtaining module 1404 is configured to: determine a sound effect performance manner of the environment object included in the environment type corresponding to the environment sound effect layer, and set a sound effect type for the environment sound effect layer based on the sound effect performance manner;
determine sound effect content of the environment sound effect layer in at least one preset performance dimension, and determine an environment sound effect event corresponding to the environment sound effect layer based on the sound effect content, the environment sound effect event being an event that triggers playback of the sound effect content in the at least one preset performance dimension; and
determine, based on the sound effect type, a driving mode corresponding to the environment data included in the environment sound effect layer.

In another possible implementation of the embodiments of this application, the apparatus 1400 further includes a third obtaining module,
the third obtaining module being configured to obtain a sound effect resource file corresponding to the audio configuration file of each environment sound effect layer.

In another possible implementation of this embodiment of this application, when determining, based on the at least one environment type, at least one environment sound effect layer included in the virtual scene, the second determining module 1403 is specifically configured to:
determine the environment sound effect layer corresponding to the environment type depending on whether the same sound effect content is designed for the environment object in each environment type.

In another possible implementation of this embodiment of this application, when determining, based on the sound effect type, a driving mode corresponding to the environment data included in the environment sound effect layer, the first obtaining module 1404 is specifically configured to:
determine, based on the sound effect type, at least one driving mode supported by the environment sound effect layer;
determine each data type of the environment data; and
determine, from the at least one driving mode, a driving mode corresponding to each data type as the driving mode corresponding to the environment sound effect layer based on a mapping relationship between the data type and the driving mode.

In another possible implementation of the embodiments of this application, when obtaining environment data of the at least one environment object, the second obtaining module 1405 is specifically configured to:
obtain a distribution range of each environment object;
determine a distribution type of each environment object based on the distribution range; and
obtain environment data of each environment object based on the distribution type.

In another possible implementation of this embodiment of this application, the distribution type is a point distribution type, a limited area distribution type, or a continuous distribution type.

When obtaining environment data of each environment object based on the distribution type, the second obtaining module 1405 is specifically configured to:
obtain spatial position information of the environment object as the environment data of the environment object if the distribution type of the environment object belongs to the point distribution type;
mesh a spatial area in which the environment object is located if the distribution type of the environment object belongs to the limited area distribution type, determine, from an obtained mesh, a mesh that overlaps with the environment object, and use position information of the overlapping mesh as the environment data of the environment object; and
obtain plane bitmap data of the environment object as the environment data of the environment object if the distribution type of the environment object belongs to the continuous distribution type.

In another possible implementation of this embodiment of this application, the distribution type is a point distribution type, a limited area distribution type, or a continuous distribution type. The apparatus 1400 further includes: a compression and encoding module, configured to perform meshing processing on the environment data if the environment object included in an environment sound effect layer is consistent with at least two of the point distribution type, the limited area distribution type, or the continuous distribution type, and compress and encode the environment data obtained after the meshing processing, the meshing processing being 3D meshing processing or 2D meshing processing.

In another possible implementation of this embodiment of this application, when rendering and playing an environment audio based on the sound effect configuration file and the environment data, the audio playback control module 1406 is specifically configured to:
determine a sound effect control parameter of each environment object based on the environment data;
determine a driving mode of each environment data from the sound effect configuration file based on the data type of the environment data of each environment object;
obtain a sound effect resource file, the sound effect resource file including at least one sound effect resource corresponding to each sound effect content; and
render and play the at least one sound effect resource based on the driving mode and the sound effect control parameter.

In another possible implementation of this embodiment of this application, the apparatus 1400 further includes: a fourth obtaining module, configured to obtain second dynamic control factor control data, the second dynamic control factor control data including a control parameter corresponding to at least one piece of sound effect content.

When rendering and playing an environment audio based on the sound effect configuration file and the environment data, the audio playback control module 1406 is specifically configured to:
render and play the environment audio through the second dynamic control factor control data based on the sound effect configuration file and the environment data. The display module 1401, the first determining module 1402, the second determining module 1403, and a fourth determining module may be the same determining module, or may be partially the same determining module, or may all be different determining modules. The first obtaining module 1404, the second obtaining module 1405, the third obtaining module, and the fourth obtaining module may be the same obtaining module, or may be different obtaining modules, or may be partially the same obtaining modules, which is not limited in the embodiments of this application.

An embodiment of this application provides an environment audio processing apparatus. In this embodiment of this application, after the virtual scene is determined, the environment type included in the scene may be determined, to determine at least one environment sound effect layer included in the target sound effect scene. After the environment sound effect layer is determined, the sound effect configuration file corresponding to each environment sound effect layer may be obtained from a pre-configured sound effect configuration file, and after the environment data in the virtual scene is obtained, rendering and playback of the virtual scene audio may be controlled through the determined sound effect configuration file and the obtained environment data of the virtual scene, so as to render and play the environment audio.

The apparatus in the embodiments of this application may perform the method provided in the embodiments of this application, and an implementation principle thereof is similar. Actions performed by each module in the apparatus in the embodiments of this application correspond to operations in the method in the embodiments of this application. For detailed descriptions of functions of each module of the apparatus, reference may be made to the foregoing descriptions of the corresponding methods. Details are not described herein again.

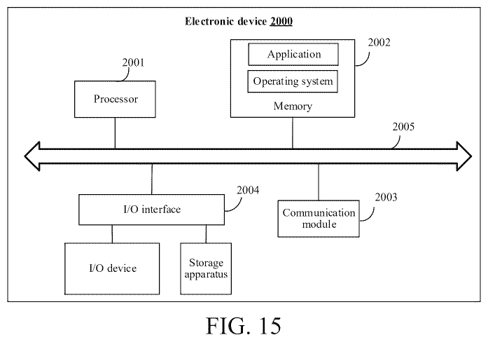

FIG. 15 is a schematic structural diagram of an electronic device applicable to an embodiment of this application. As shown in FIG. 15, the electronic device may be a server or a terminal device. The electronic device may be configured to implement the method provided in any one embodiment of this application.

As shown in FIG. 15, an electronic device 2000 may mainly include components such as at least one processor 2001 (one processor is shown in FIG. 15), a memory 2002, a communication module 2003, and an input/output interface 2004. In one embodiment, each component may be connected and communicated through a bus 2005. The structure of the electronic device 2000 shown in FIG. 15 is merely exemplary, and does not constitute a limitation to the electronic device applicable to the method provided in the embodiments of this application.

The memory 2002 may be configured to store an operating system, an application, and the like. The application may include a computer program implementing the method provided in the embodiments of the present disclosure when being called by the processor 2001, and may further include a program configured for implementing another function or service. The memory 2002 may be a read only memory (ROM) or another type of static storage device that can store static information and instructions, a random access memory (RAM) or another type of dynamic storage device that can store information and computer programs, or may be an electrically erasable programmable read only memory (EEPROM), a compact disc read only memory (CD-ROM) or another optical disk memory, an optical disk memory (including a compact disc, a laser disk, an optical disk, a digital universal disk, a blue-ray disc, and the like), a magnetic disk storage medium or another magnetic storage device, or any other medium that can be configured to carry or store expected program codes in an instruction or a data structure form and that can be accessed by a computer, but it is not limited thereto.

The processor 2001 is connected to the memory 2002 through the bus 2005, and implements corresponding functions by calling the applications stored in the memory 2002. The processor 2001 may be a central processing unit (CPU), a general purpose processor, a digital signal processor (DSP), an application specific integrated circuit (ASIC), a field programmable gate array (FPGA), or another programmable logic device, a transistor logic device, a hardware component or any combination thereof, and it may implement or perform various exemplary logic boxes, modules, and circuits with reference to descriptions of the disclosed contents of the present disclosure. Alternatively, the processor 2001 may be a combination of processors implementing a computing function, for example, a combination including one or more microprocessors, or a combination of a DSP and a microprocessor.

The electronic device 2000 may be connected to a network through the communication module 2003 (may include, but not limited to, components such as a network interface) to communicate with another device (such as a user terminal or a server) through the network for implementing interaction of data, such as transmit data to the another device, or may receive data transmitted by the another device. The communication module 2003 may include a wired network interface, and/or a wireless network interface, and the like. In other words, the communication module may include at least one of a wired communication module or a wireless communication module.

The electronic device 2000 may be connected to a required input/output device such as a keyboard or a display device through the input/output interface 2004. The electronic device 2000 may have a display device, or may be externally connected with another display device through the interface 2004. In one embodiment, a storage apparatus such as a hard disk may further be connected through the interface 2004, so that data in the electronic device 2000 may be stored into the storage apparatus, or data in the storage apparatus may be read, and data in the storage apparatus may further be stored into the memory 2002. The input/output interface 2004 may be a wired interface, or may be a wireless interface. Based on different actual application scenes, a device connected to the input/output interface 2004 may be a component of the electronic device 2000, or may be an external device connected with the electronic device 2000 when required.

The bus 2005 configured to connect each component may include a channel to transmit information among the foregoing components. The bus 2005 may be a peripheral component interconnect (PCI) bus, an extended industry standard architecture (EISA) bus, or the like. Based on different functions, the bus 2005 may be classified into an address bus, a data bus, a control bus, and the like.

In one embodiment, for the solutions provided in the embodiments of this application, the memory 2002 may be configured to store a computer program implementing the solutions of this application and is run by the processor 2001. When running the computer program, the processor 2001 implements the method or actions of the apparatus provided in the embodiments of this application.

Based on the principle the same as the method provided in the embodiments of this application, the embodiments of this application provide a non-transitory computer-readable storage medium. The computer-readable storage medium has a computer program stored therein, and the computer program, when executed by the processor, may implement corresponding contents of the foregoing method embodiments.

An embodiment of this application further provides a computer program product. The computer program product includes a computer program. The computer program, when executed by the processor, may implement corresponding contents of the foregoing method embodiments.

The terms such as “first”, “second”, “third”, “fourth”, “1”, and “2” (if any) in the specification and claims of this application and in the foregoing accompanying drawings are configured for distinguishing similar objects and not necessarily configured for describing a particular order or sequence. Data used in this way is exchangeable in a proper case, so that the embodiments of this application described herein can be implemented in an order other than that illustrated or described in the drawings or text.

Although each operation is indicated by the arrows in the flowcharts of the embodiments of this application, the order of the implementation of these operations is not limited to the order indicated by the arrows. Unless otherwise explicitly specified, in some implementation scenes of the embodiments of this application, the implementation operations in each flowchart may be performed in another order as required. In addition, some or all of the operations in each flowchart may include a plurality of sub-operations or a plurality of stages based on an actual implementation scene. Some or all of these sub-operations or stages may be performed at the same moment, and each of these sub-operations or stages may be respectively performed at a different moment. In a scene with different implementation moments, an implementation order of these sub-operations or stages may be flexibly configured based on a requirement. This is not limited in the embodiments of this application.

In the embodiments of this application, the term “module” refers to a computer program with a preset function or a part of the computer program and works, together with other related parts, to implement a preset target, which may be completely or partially implemented by using software, hardware (such as a processing circuit or a memory) or a combination thereof. Similarly, one processor (or a plurality of processors or memories) may be configured to implement one or more modules. In addition, each module may be a part of an overall module including a function of the module. The foregoing descriptions are merely exemplary implementations of some implementation scenes of this application, and a person of ordinary skill in the art may use other similar implementation measures based on the technical concepts of this application on the promise without departing from the technical concepts of the solutions of this application, and these contents also fall within the protection scope of the embodiments of this application.

What is claimed is:

1. A method for processing an environment audio in a virtual scene performed by an electronic device, the method comprising:
displaying a user interface, the user interface comprising a virtual scene and the virtual scene comprising at least one environment object;
determining at least one environment type corresponding to the virtual scene based on an attribute of the at least one environment object;
determining, based on the at least one environment type, at least one environment sound effect layer comprised in the virtual scene;
generating a sound effect configuration file for each environment sound effect layer, and obtaining environment data of the at least one environment object; and
rendering and playing an environment audio based on the sound effect configuration file and the environment data.

2. The method according to claim 1, wherein the determining at least one environment type corresponding to the virtual scene based on an attribute of the at least one environment object comprises:
determining, from a plurality of candidate object types, a target object type to which each environment object belongs as the at least one environment type.

3. The method according to claim 1, wherein the audio configuration file comprises at least one of the following:
at least one of a sound effect type corresponding to the environment sound effect layer, an environment sound effect event, or a driving mode of the environment data,
the environment sound effect event comprising at least one piece of sound effect content;
the driving mode being a manner of controlling playback of the environment audio through the environment data comprised in the environment sound effect layer; a sound effect resource file, comprising at least one sound effect resource corresponding to each sound effect content; and
first dynamic control data, comprising a control parameter corresponding to the at least one piece of sound effect content.

4. The method according to claim 1, wherein the generating a sound effect configuration file for each environment sound effect layer comprises:
determining a sound effect performance manner of the environment object comprised in the environment type corresponding to the environment sound effect layer;
setting the sound effect type for the environment sound effect layer based on the sound effect performance manner;
determining sound effect content of the environment sound effect layer in at least one preset performance dimension, and determining an environment sound effect event corresponding to the environment sound effect layer based on the sound effect content, the environment sound effect event being an event that triggers playback of the sound effect content in the at least one preset performance dimension; and
determining, based on the sound effect type, a driving mode corresponding to the environment data comprised in the environment sound effect layer.

5. The method according to claim 1, wherein the determining, based on the at least one environment type, at least one environment sound effect layer comprised in the virtual scene comprises:
determining the environment sound effect layer corresponding to the environment type based on whether the same sound effect content is designed for the environment object in each environment type.

6. The method according to claim 1, wherein the obtaining environment data of the at least one environment object comprises:
obtaining a distribution range of each environment object;
determining a distribution type of each environment object based on the distribution range; and
obtaining environment data of each environment object based on the distribution type.

7. The method according to claim 1, wherein the rendering and playing an environment audio based on the sound effect configuration file and the environment data comprises:
determining a sound effect control parameter of each environment object based on the environment data;
determining a driving mode of each environment data from the sound effect configuration file based on the data type of the environment data of each environment object;
obtaining a sound effect resource file, the sound effect resource file comprising at least one sound effect resource corresponding to each sound effect content; and
rendering and playing the at least one sound effect resource based on the driving mode and the sound effect control parameter.

8. The method according to claim 1, further comprising:
obtaining second dynamic control factor control data, the second dynamic control factor control data comprising a control parameter corresponding to at least one piece of sound effect content; and
rendering and playing the environment audio through the second dynamic control factor control data based on the sound effect configuration file and the environment data.

9. The method according to claim 1, wherein the generating a sound effect configuration file for each environment sound effect layer comprises:
obtaining a scene sound effect configuration file corresponding to the virtual scene, the scene sound effect configuration file comprising the sound effect configuration file corresponding to each environment sound effect layer; and
obtaining the sound effect configuration file corresponding to each environment sound effect layer from the scene sound effect configuration file based on a preset first mapping relationship.

10. The method according to claim 1, wherein the generating a sound effect configuration file for each environment sound effect layer comprises:
obtaining an overall sound effect configuration file, the overall sound effect configuration file comprising a scene sound effect configuration file corresponding to each virtual scene;
obtaining the scene sound effect configuration file corresponding to the virtual scene from the overall sound effect configuration file; and
obtaining the sound effect configuration file corresponding to each environment sound effect layer from the scene sound effect configuration file based on a preset first mapping relationship.

11. An electronic device, comprising a memory and a processor, the memory having a computer program stored therein, and the computer program, when executed by the processor, causing the electronic device to implement a method for processing an environment audio in a virtual scene including:
displaying a user interface, the user interface comprising a virtual scene and the virtual scene comprising at least one environment object;
determining at least one environment type corresponding to the virtual scene based on an attribute of the at least one environment object;
determining, based on the at least one environment type, at least one environment sound effect layer comprised in the virtual scene;
generating a sound effect configuration file for each environment sound effect layer, and obtaining environment data of the at least one environment object; and
rendering and playing an environment audio based on the sound effect configuration file and the environment data.

12. The electronic device according to claim 11, wherein the determining at least one environment type corresponding to the virtual scene based on an attribute of the at least one environment object comprises:
determining, from a plurality of candidate object types, a target object type to which each environment object belongs as the at least one environment type.

13. The electronic device according to claim 11, wherein the audio configuration file comprises at least one of the following:
at least one of a sound effect type corresponding to the environment sound effect layer, an environment sound effect event, or a driving mode of the environment data,
the environment sound effect event comprising at least one piece of sound effect content;
the driving mode being a manner of controlling playback of the environment audio through the environment data comprised in the environment sound effect layer; a sound effect resource file, comprising at least one sound effect resource corresponding to each sound effect content; and
first dynamic control data, comprising a control parameter corresponding to the at least one piece of sound effect content.

14. The electronic device according to claim 11, wherein the generating a sound effect configuration file for each environment sound effect layer comprises:
determining a sound effect performance manner of the environment object comprised in the environment type corresponding to the environment sound effect layer;
setting the sound effect type for the environment sound effect layer based on the sound effect performance manner;
determining sound effect content of the environment sound effect layer in at least one preset performance dimension, and determining an environment sound effect event corresponding to the environment sound effect layer based on the sound effect content, the environment sound effect event being an event that triggers playback of the sound effect content in the at least one preset performance dimension; and
determining, based on the sound effect type, a driving mode corresponding to the environment data comprised in the environment sound effect layer.

15. The electronic device according to claim 11, wherein the determining, based on the at least one environment type, at least one environment sound effect layer comprised in the virtual scene comprises:
determining the environment sound effect layer corresponding to the environment type based on whether the same sound effect content is designed for the environment object in each environment type.

16. The electronic device according to claim 11, wherein the obtaining environment data of the at least one environment object comprises:
obtaining a distribution range of each environment object;
determining a distribution type of each environment object based on the distribution range; and
obtaining environment data of each environment object based on the distribution type.

17. The electronic device according to claim 11, wherein the rendering and playing an environment audio based on the sound effect configuration file and the environment data comprises:
determining a sound effect control parameter of each environment object based on the environment data;
determining a driving mode of each environment data from the sound effect configuration file based on the data type of the environment data of each environment object;
obtaining a sound effect resource file, the sound effect resource file comprising at least one sound effect resource corresponding to each sound effect content; and
rendering and playing the at least one sound effect resource based on the driving mode and the sound effect control parameter.

18. The electronic device according to claim 11, wherein the method further comprises:
obtaining second dynamic control factor control data, the second dynamic control factor control data comprising a control parameter corresponding to at least one piece of sound effect content; and
rendering and playing the environment audio through the second dynamic control factor control data based on the sound effect configuration file and the environment data.

19. The electronic device according to claim 11, wherein the generating a sound effect configuration file for each environment sound effect layer comprises:
obtaining a scene sound effect configuration file corresponding to the virtual scene, the scene sound effect configuration file comprising the sound effect configuration file corresponding to each environment sound effect layer; and
obtaining the sound effect configuration file corresponding to each environment sound effect layer from the scene sound effect configuration file based on a preset first mapping relationship.

20. A non-transitory computer-readable storage medium, having a computer program stored therein, the computer program, when executed by a processor of an electronic device, causing the electronic device to implement a method for processing an environment audio in a virtual scene including:
displaying a user interface, the user interface comprising a virtual scene and the virtual scene comprising at least one environment object;
determining at least one environment type corresponding to the virtual scene based on an attribute of the at least one environment object;
determining, based on the at least one environment type, at least one environment sound effect layer comprised in the virtual scene;
generating a sound effect configuration file for each environment sound effect layer, and obtaining environment data of the at least one environment object; and
rendering and playing an environment audio based on the sound effect configuration file and the environment data.
